(19) United States
(12) Patent Application Publication
(10) Pub. No.: US 2007/0139597 A1
(43) Pub. Date: Jun. 21, 2007

(54) DISPLAY SUBSTRATE, METHOD OF MANUFACTURING THE SAME AND DISPLAY DEVICE HAVING THE SAME

(75) Inventors: Yi-Seop Shim, Gyeonggi-do (KR); Gug-Rae Jo, Chungcheongnam-do (KR); Byoung-Joo Kim, Gyeonggi-do (KR); Ji-Won Choi, Seoul (KR); Jang-Soo Kim, Gyeonggi-do (KR); Shi-Yul Kim, Gyeonggi-do (KR); Jin-Ho Ju, Seoul (KR); Chong-Chul Chai, Seoul (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/559,589

(22) Filed: Nov. 14, 2006

(30) Foreign Application Priority Data
Nov. 15, 2005 (KR) 2005-109252
Apr. 25, 2006 (KR) 2006-37193

(51) Int. Cl. G02F 1/1343; G02F 1/1335

(52) U.S. Cl. 349/139; 349/106

(57) ABSTRACT

A display substrate includes a thin film transistor layer, a color filter layer, a plurality of pixel electrodes, a first cover layer and an alignment layer. The thin film transistor layer includes a plurality of pixel regions. The color filter layer is formed on the thin film transistor layer. The pixel electrodes are formed on the color filter layer with at least one gap defined between adjacent pixel electrodes. The first cover layer is provided in the gap between adjacent pixel electrodes and covers a portion of the color filter layer exposed by the gap between the pixel electrodes. The alignment layer is formed on the pixel electrodes and the first cover layer. Therefore, the color filter layer is spaced apart from the alignment layer to decrease an afterimage, thereby improving an image display quality

### CROSS-REFERENCE TO RELATED APPLICATIONS

The present application claims priority from Korean Patent Application No. 2005-109252, filed on Nov. 15, 2005, and Korean Patent Application No. 2006-37193, filed on Apr. 25, 2006, the disclosures of which are hereby incorporated herein by reference in their entireties.

### BACKGROUND OF THE INVENTION

1. Field of the Invention

The present invention relates to a display substrate, a method of manufacturing the display substrate and a display device having the display substrate. More particularly, the present invention relates to a display substrate capable of decreasing an afterimage to improve image display quality, a method of manufacturing the display substrate and a display device having the display substrate.

2. Description of the Related Art

An electronic apparatus such as a notebook computer, a monitor, a television receiver set, etc., includes a display device for displaying an image. The display device may be a flat panel display device such as a liquid crystal display (LCD) device, an organic light emitting display (OLED) device, etc.

The LCD device comprises a lower substrate comprising a thin film transistor (TFT), an upper substrate comprising a color filter facing the lower substrate, and a liquid crystal layer interposed between the lower substrate and the upper substrate.

The lower substrate comprises an insulating substrate, a signal line, a TFT, a pixel electrode, etc., to independently drive a plurality of pixels. The signal line, the TFT and the pixel electrode are formed on the insulating substrate. The upper substrate comprises a color filter layer and a common electrode. The color filter layer comprises a red color filter, a green color filter and a blue color filter. The common electrode faces the pixel electrode.

The image display quality of an LCD device varies based on the alignment between the lower substrate and the upper substrate. That is, when the lower substrate is misaligned with respect to the upper substrate, the image display quality of the LCD device deteriorates.

In order to prevent the deterioration of the image display quality of the LCD device, an LCD device having a color filter on array (COA) structure has been devised. In the LCD device having the COA structure, the color filter layer having the red, green and blue color filters is generally formed on the lower substrate.

The color filter layer of the LCD device having the COA structure makes contact with an alignment layer through openings between adjacent pixel electrodes. Ion particles in the color filter layer may migrate into the liquid crystal layer through the alignment layer, thereby deteriorating the electrical and optical characteristics of liquid crystals in the liquid crystal layer. This can result in an undesirable afterimage phenomenon.

### SUMMARY OF THE INVENTION

A display substrate with improved image display quality and reduced afterimage problems is provided.

A method of manufacturing the above-mentioned display substrate is provided.

A display device having the above-mentioned display substrate is provided.

A display substrate in accordance with one aspect of the present invention comprises a thin film transistor layer, a color filter layer, a plurality of pixel electrodes, a first cover layer provided in the gap between adjacent pixel electrodes, and an alignment layer. The thin film transistor layer comprises a plurality of pixel regions. The color filter layer is formed on the thin film transistor layer. The pixel electrodes are formed on the color filter layer. At least one gap is defined between adjacent pixel electrodes. The first cover layer covers a portion of the color filter layer exposed by the gap between the adjacent pixel electrodes. The alignment layer is formed on the pixel electrodes and the first cover layer.

A method of manufacturing a display substrate in accordance with another aspect of the present invention is provided as follows. A thin film transistor layer comprising a plurality of pixel regions is formed on an insulating substrate. A color filter layer is formed on the thin film transistor layer. A plurality of pixel electrodes is formed on the color filter layer. A first cover layer that covers a portion of the color filter layer is formed between pixel electrodes. An alignment layer is formed on the pixel electrodes and the first cover layer.

A display device in accordance with still another aspect of the present invention comprises a display substrate, an opposite substrate and a liquid crystal layer interposed between the display substrate and the opposite substrate. The display substrate comprises a thin film transistor layer, a color filter layer, a plurality of pixel electrodes, at least one gap between adjacent pixel electrodes, a cover layer and a first alignment layer. The thin film transistor layer comprises a plurality of pixel regions arranged in a matrix shape. The color filter layer is formed on the thin film transistor layer. The pixel electrodes are formed on the color filter layer. The cover layer is provided in the gap between adjacent pixel electrodes and covers a portion of the color filter layer exposed by the gap between the adjacent pixel electrodes. The first alignment layer is formed on the pixel electrodes and the cover layer. The opposite substrate is combined with the display substrate, and faces the display substrate. The liquid crystal layer is interposed between the display substrate and the opposite substrate.

The opposite substrate may include a common electrode formed on an insulating substrate facing the display substrate, and a second alignment layer formed on the common electrode.

According to the display substrate, the method of manufacturing the display substrate and the display device having the display substrate of the present invention, the color filter layer is spaced apart from the alignment layer to decrease an afterimage, thereby improving an image display quality.

### BRIEF DESCRIPTION OF THE DRAWINGS

The present invention will become more apparent by describing in detail example embodiments thereof with reference to the accompanying drawings, in which:

FIG. 1 is a plan view illustrating a display substrate in accordance with one embodiment of the present invention;

FIG. 2 is a cross-sectional view taken along a line I-I′ shown in FIG. 1;

FIG. 3 is a plan view illustrating a display substrate in accordance with another embodiment of the present invention;

FIGS. 4 to 7 are cross-sectional views illustrating a method of manufacturing the display substrate shown in FIGS. 1 and 2;

FIG. 8 is a cross-sectional view taken along a line II-II′ illustrating a display substrate in accordance with another embodiment of the present invention;

FIGS. 9 to 13 are cross-sectional views illustrating a method of manufacturing a display substrate shown in FIG. 8;

FIG. 14 is a plan view illustrating a display substrate in accordance with another embodiment of the present invention;

FIG. 15 is a cross-sectional view taken along a line III-III′ of FIG. 14; and

FIG. 16 is a cross-sectional view illustrating a display device in accordance with another embodiment of the present invention.

### DESCRIPTION OF THE EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will typically have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

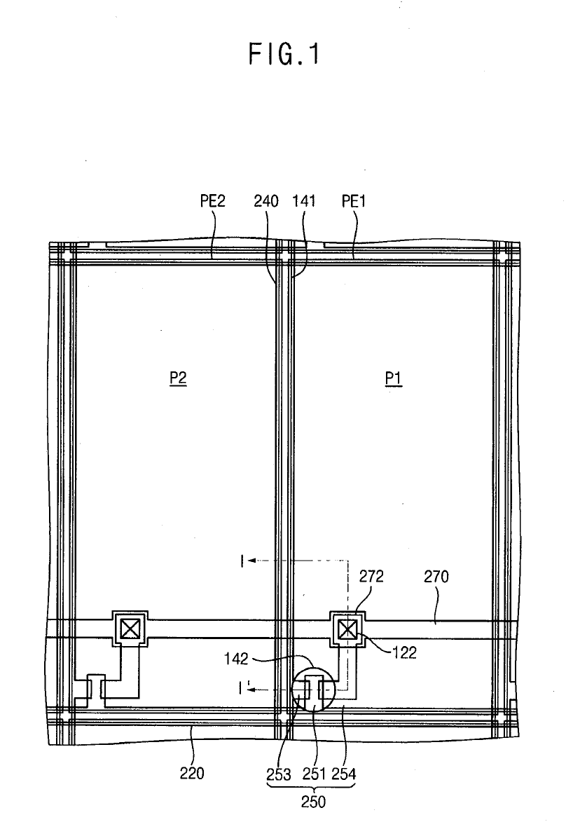

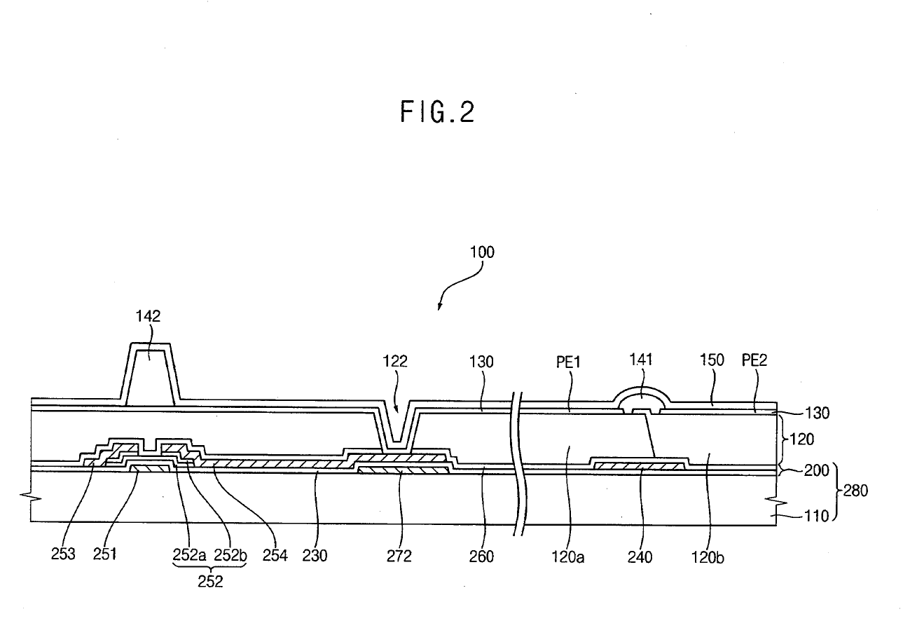

FIG. 1 is a plan view illustrating a display substrate in accordance with one embodiment of the present invention. FIG. 2 is a cross-sectional view taken along a line I-I′ shown in FIG. 1.

Referring to FIGS. 1 and 2, the display substrate 100 comprises a thin film transistor (TFT) layer 280, a color filter layer 120, a pixel electrode layer 130, a first cover layer 141 and a first alignment layer 150. The TFT layer 280 comprises an insulating substrate 110 and a pixel layer 200.

The insulating substrate 110 comprises a transparent material and can be formed by, for example, a glass substrate.

The pixel layer 200 is formed on the insulating substrate 110. The pixel layer 200 comprises a plurality of pixel regions P1 and P2 arranged in a matrix shape on the insulating substrate 110.

The pixel layer 200 comprises a plurality of gate lines 220, a gate insulating layer 230, a plurality of data lines 240, a TFT 250 and a passivation layer 260. Alternatively, the pixel layer may further include a plurality of TFTs.

The gate lines 220 on the insulating substrate 110 separate a first pixel region P1 from an adjacent third pixel region (not shown) that is below the first pixel region P1 (as seen from the perspective shown in FIG. 1).

The gate insulating layer 230 is formed on the insulating layer 110 and covers the gate lines 220. The gate insulating layer 230 comprises an insulating material such as silicon nitride (SiNx), silicon oxide (SiOx), etc. A thickness of the gate insulating layer 230 may be, for example, about 4,500 Å.

The data lines 240 on the gate insulating layer 230 separate the adjacent first and second pixel regions P1 and P2.

One of the TFTs 250 is formed in the first pixel region P1, and is electrically connected to the gate and data lines 220 and 240. The TFT 250 applies an image signal to a first pixel electrode PE1 through the data line 240 based on a scan signal that is applied to the TFT 250 through the gate line 220. Another TFT (not shown) in the second pixel region P2 applies an image signal to a second pixel electrode PE2 through another data line (not shown) based on the scan signal that is applied to the TFT (not shown) through the gate line 220.

The TFT 250 comprises a gate electrode 251, an active layer 252, a source electrode 253 and a drain electrode 254.

The gate electrode 251 is electrically connected to each of the gate lines 220, and functions as a gate terminal of the TFT 250.

The active layer 252 is formed on the gate insulating layer 230 corresponding to the gate electrode 251. The active layer 252 comprises a semiconductor layer 252a and an ohmic contact layer 252b. The semiconductor layer 252a may comprise amorphous silicon (a-Si). The ohmic contact layer 252b may be made of n+ amorphous silicon implanted by n+impurities at a high concentration.

The source electrode 253 is electrically connected to each of the data lines 240, and extends to an upper portion of the active layer 252. The source electrode 253 functions as a source terminal of the TFT 250.

The drain electrode 254 is formed on the active layer 252, and is spaced apart from the source electrode 253. The drain electrode 254 functions as a drain terminal of the TFT 250. The drain electrode 254 is electrically connected to the first pixel electrode PE1 through a contact hole 122 that is formed through the passivation layer 260 and the color filter layer 120.

The source electrode 253 and the drain electrode 254 are formed on the active layer 252, with region between the source electrode 253 and the drain electrode 254 defining a channel of the TFT in the semiconductor layer 252a.

The passivation layer 260 is formed on the gate insulating layer 230 and covers the data lines 240 and the TFT 250. The passivation layer 260 comprises an insulating material such as silicon nitride (SiNx), silicon oxide (SiOx), etc. A thickness of the passivation layer 260 may be about 2,000 Å.

The pixel layer 200 may further include a storage line 270 and a storage electrode 272. The storage line 270 is formed between the gate lines 220, and extends substantially in parallel with the gate lines 220. The storage electrode 272 is electrically connected to the storage line 270. The storage electrode 272 is formed in each first pixel region P1. The storage line 270 and the storage electrode 272 may be formed from the same layer as the gate lines 220. The storage electrode 272 is formed opposite to the drain electrode 254 with respect to the gate insulating layer 230 to form a storage capacitor Cst. The storage capacitor Cst maintains the image signal that is applied to the first pixel electrode PE1 through the TFT 250 during one frame.

The color filter layer 120 is formed on the pixel layer 200. The color filter layer 120 comprises a red (R) color filter, a green (G) color filter and a blue (B) color filter. In particular, a first color filter 120a is formed in the first pixel region P1, and a second color filter 120b is formed in the second pixel region P2. The color filter layer 120 arranged on the pixel layer 200 has a predetermined pattern so that the R, G and B color filters are uniformly arranged. Alternatively, the color filter layer 120 may further include a transparent color filter for displaying white light.

The pixel electrode layer 130 includes the first and second pixel electrodes PE1 and PE2 formed in the first and second pixel regions P1 and P2, respectively. In particular, the first pixel electrode PE1 is formed on the first color filter 120a in the first pixel region P1. The first pixel electrode PE1 is electrically connected to the drain electrode 254 of the TFT 250 through the contact hole 122 that is formed through the passivation layer 260 and the first color filter 120a.

The pixel electrode layer 130 comprises a transparent conductive material such as indium zinc oxide (IZO), indium tin oxide (ITO), etc.

Gaps are formed in the pixel electrode layer 130 at a boundary between adjacent pixel electrodes PE1 and PE2. That is, the pixel electrodes PE1 and PE2 in the pixel electrode layer 130 are electrically and physically disconnected at portions corresponding to the gate and data lines 220 and 240. Therefore, the color filter layer 120 between the pixel electrodes PE1 and PE2 is exposed through a space corresponding to the gate and data lines 220 and 240.

The first cover layer 141 covers the portion of the color filter layer 120 that is exposed between the pixel electrodes PE1 and PE2. That is, the first cover layer 141 is formed on the color filter layer 120 on portions corresponding to the gate and data lines 220 and 240. The first cover layer 141 prevents direct contact between the color filter layer 120 and the alignment layer 150 through the gap between the pixel electrodes PE1 and PE2.

The first cover layer 141 substantially covers the entire exposed region between the pixel electrodes PE1 and PE2. A thickness of the first cover layer 141 may be about 0.4 μm to about 0.6 μm, and a width of the first cover layer 141 may be about 5 μm to about 8 μm.

The first cover layer 141 may comprise a light curable resin or a thermosetting resin. When the first cover layer 141 comprises a light curable resin, the first cover layer 141 may be formed using a photolithography process. In this case, the light curable resin may comprise a negative photoresist, a positive photoresist. In addition, when the first cover layer 141 comprises a thermosetting resin, the first cover layer 141 may be formed using an ink jet deposition process or a flat printing process. In the ink jet deposition process, the thermosetting resin is deposited on the color filter layer 120 between the pixel electrodes PE1 and PE2. In the flat printing process, the thermosetting resin is printed on the color filter layer 120 between the pixel electrodes PE1 and PE2.

The alignment layer 150 is formed on the pixel electrode layer 130 and the first cover layer 141. The alignment layer 150 aligns liquid crystal molecules arranged on an upper surface of the alignment layer 150.

The display substrate 100 may further include a column spacer 142 to maintain a cell gap between the display substrate 100 and an opposing substrate (not shown). The column spacer 142 protrudes from the display substrate 100 in a region in which the gate lines 220 cross the data lines 240, and has a greater height than the first cover layer 141. The column spacer 142 may be formed on the TFT 250. For example, the column spacer 142 may have a height of about 1.0 μm to about 1.5 μm, and a width of about 10 μm to about 15 μm.

The column spacer 142 may be formed substantially from the same layer as the first cover layer 141, and may comprise substantially the same material as the first cover layer 141 such as a negative photoresist, a positive photoresist, etc. In other embodiments, different types of structures, such as a ball-shaped structure, may be used to maintain the gap the display substrate 100 and the opposing substrate.

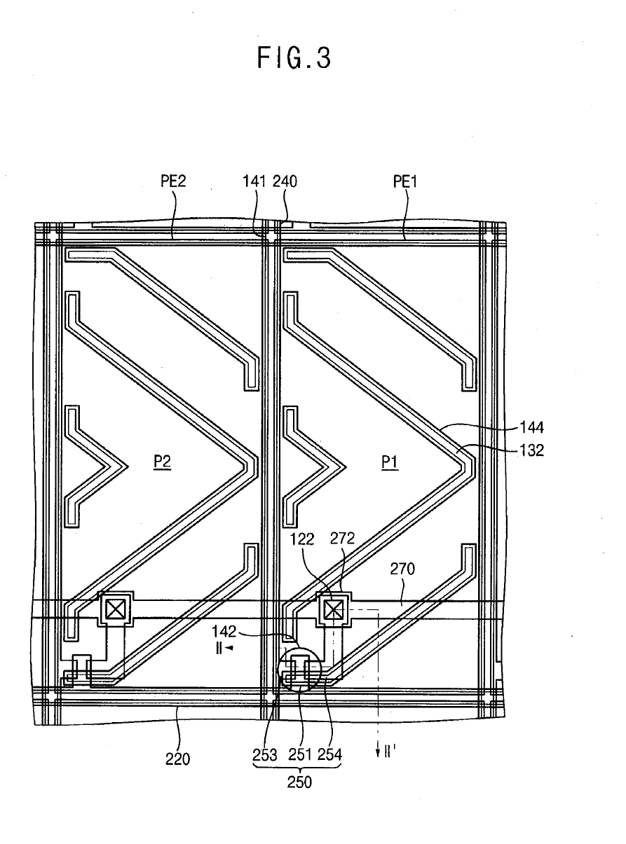

FIG. 3 is a plan view illustrating a display substrate in accordance with another embodiment of the present invention. The display substrate of FIG. 3 is substantially the same as in FIGS. 1 and 2 except for the pixel electrodes. Thus, the same reference numerals will be used to refer to the same or like parts as those described in FIGS. 1 and 2 and any further description concerning the above elements will be omitted.

Referring to FIGS. 2 and 3, a first pixel electrode PE1 includes an opening 132 which divides a first pixel region P1 into a plurality of domains. Alternatively, the first pixel electrode PE1 may further include a plurality of openings 132, which divide the first pixel region P1 into several domains. Liquid crystals in each of the domains are arranged in different directions from each other by the opening(s) 132 of the first pixel electrode PE1, thereby increasing a viewing angle of a display device.

The display substrate 100 may further include a color filter layer 120 (shown in FIG. 2) and a second cover layer 144. The second cover layer 144 covers an portion of the color filter layer 120 that is exposed through the opening(s) 132 in the first pixel electrode PE1. The second cover layer 144 prevents direct contact between the color filter layer 120 and an alignment layer 150 through the opening(s) 132 in the first pixel electrode PE1.

The second cover layer 144 may be formed from substantially the same layer as the first cover layer 141 and the column spacer 142, and may comprise substantially the same material as the first cover layer 141 and the column spacer 142.

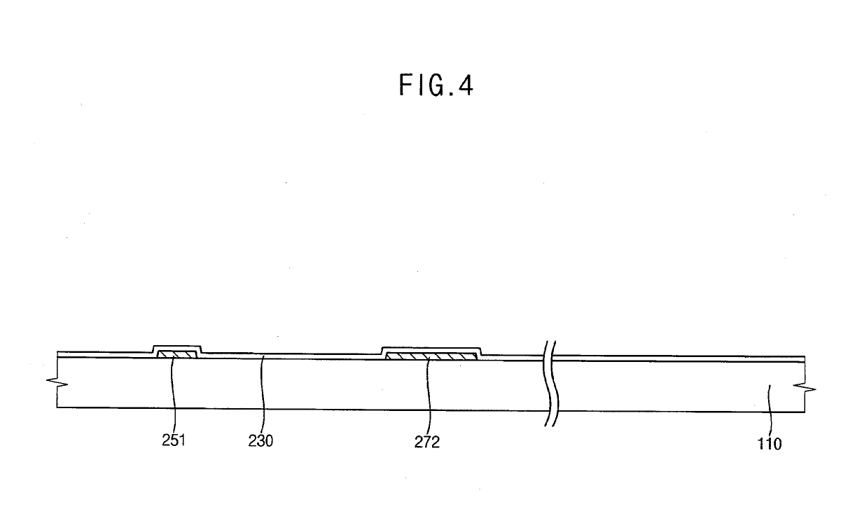

FIGS. 4 to 7 are cross-sectional views illustrating a method of manufacturing the display substrate shown in FIGS. 1 and 2.

Referring to FIGS. 1 and 4, a pixel layer 200 of FIG. 2 having a plurality of pixel regions P1 and P2 arranged in a matrix shape is formed on an insulating substrate 110.

More specifically, a first metal layer is deposited on the insulating substrate 110. The first metal layer is partially etched through a photolithography process to form a gate line 220 and a gate electrode 251. A plurality of gate lines 220 and a plurality of gate electrodes 251 may be formed from the first metal layer.

The gate line 220 defines a boundary between a first pixel region P1 and a third pixel region (not shown) that below the first pixel region P1 (as seen from the perspective shown in FIG. 1). The gate electrode 251 is electrically connected to the gate line 220 to function as a gate terminal of a TFT 250. A storage line 270 and a storage electrode 272 are formed from substantially the same layer as the gate line 220 and the gate electrode 251 on the insulating substrate 110. Alternatively, a storage line and a storage electrode comprising a transparent conductive material may be formed through an additional process in order to improve the opening ratio of each of the pixel regions P1 and P2.

A gate insulating layer 230 may be formed on the insulating substrate 110 so as to cover the gate line 220 and the gate electrode 251 formed on the insulating substrate 110. The gate insulating layer 230 may comprise, e.g., silicon nitride (SiNx) or silicon oxide (SiOx), and may have a thickness of about 4,500 Å.

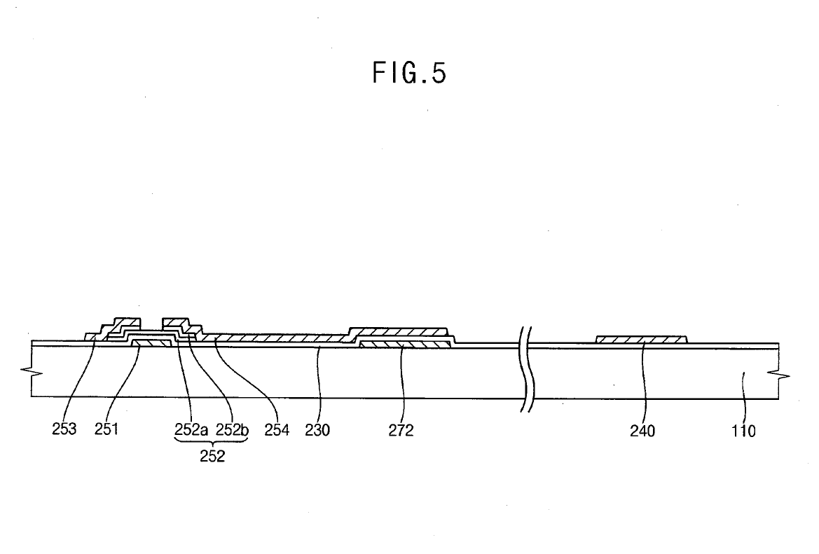

Referring to FIGS. 1 and 5, a semiconductor layer 252a and an ohmic contact layer 252b are sequentially formed on the gate insulating layer 230. The semiconductor layer 252a comprises amorphous silicon (a-Si), and the ohmic contact layer comprises n+ amorphous silicon (n+ a-Si). The semiconductor layer 252a and the ohmic contact layer 252b are partially etched through a photolithography process to form an active layer 252 corresponding to the gate electrodes 251.

A second metal layer is deposited on the gate insulating layer 230 and the active layer 252. The second metal layer is partially etched to form a drain line 240, a source electrode 253 and a drain electrode 254 through a photolithography process. Alternatively, a plurality of drain lines 240, a plurality of source electrodes 253 and a plurality of drain electrodes 254 may also be formed from the second metal layer.

The data line 240 defines a boundary between the first pixel region P1 and a second pixel region P2 that is adjacent to a side portion of the first pixel region P1. The source electrode 253 is spaced apart from the data line 240, and functions as a source terminal of the TFT 250. The drain electrode 254 is spaced apart from the source electrode 253, and functions as a drain terminal of the TFT 250. The drain electrode 254, the storage electrode 272, and the gate insulating layer 230 form a storage capacitor Cst.

The ohmic contact layer 252b between the source and drain electrodes 253 and 254 is etched so that the portion of the semiconductor layer 252a between the source and drain electrodes 253 and 254 is exposed.

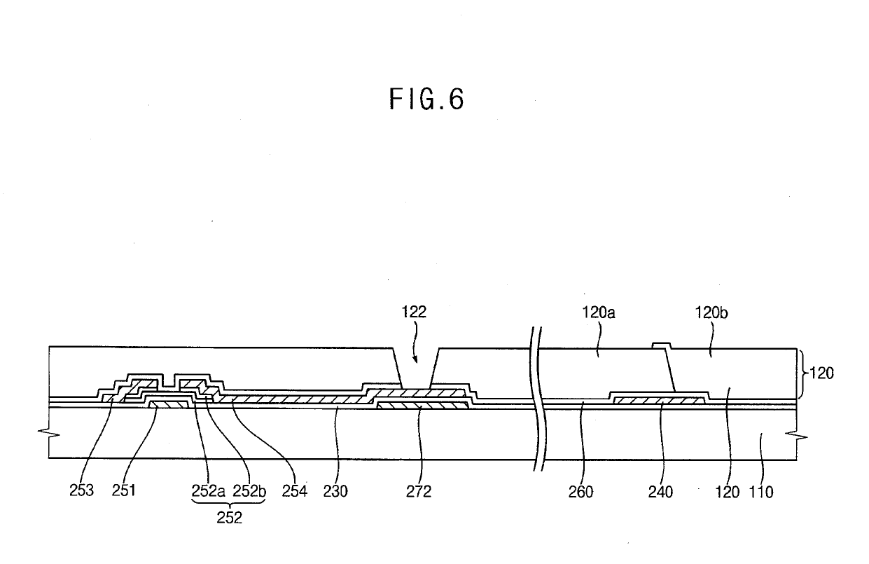

Referring to FIGS. 1 and 6, a passivation layer 260 is formed on the gate insulating layer 230, the data line 240, the source line 253 and the drain electrode 254. The passivation layer 260 comprises an insulating material such as, e.g., silicon nitride (SiNx), silicon oxide (SiOx), etc. The thickness of the passivation layer 260 may be about 2,000 Å.

A color filter layer 120 is formed on the passivation layer 260. The color filter layer 120 comprises a red (R) color filter, a green (G) color filter and a blue (B) color filter. Each of the R, G and B color filters corresponds to each of the pixel regions P1 and P2.

A contact hole 122 through which the drain electrode 254 is partially exposed is formed through the color filter layer 120 and the passivation layer 260. Alternatively, a plurality of contact holes may be formed through the color filter layer 120 and the passivation layer 260.

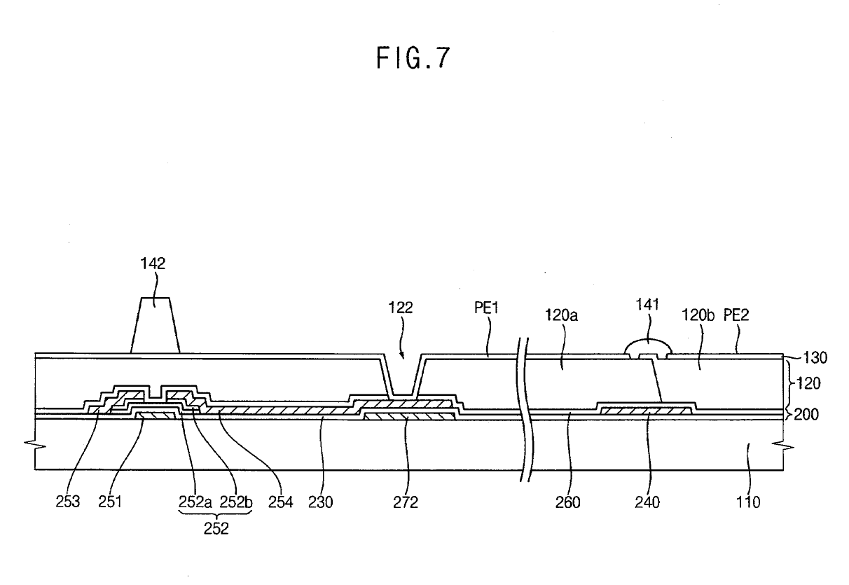

Referring to FIGS. 1 and 7, a transparent conductive layer is formed on the color filter layer 120. The transparent conductive layer is partially etched to form first and second pixel electrodes PE1 and PE2 corresponding to the pixel regions P1 and P2, respectively. Thus, the pixel electrode layer 130 is formed.

The pixel electrode layer 130 comprises a transparent conductive material, such as, e.g., indium zinc oxide (IZO), indium tin oxide, (ITO), etc.

The first pixel electrode PE1 is electrically connected to the drain electrode 254 through the contact hole 122 that is formed through the color filter layer 120 and the passivation layer 260.

A first cover layer 141 may be formed in a region between the pixel electrodes PE1 and PE2, and a column spacer 142 may be formed in a region corresponding to the TFT 250. The first cover layer 140 covers an exposed portion of the color filter layer 120 between the pixel electrodes PE1 and PE2.

The first cover layer 141 is formed on the color filter layer 120 on portions corresponding to the gate and data lines 220 and 240 that are between the adjacent pixel electrodes PE1 and PE2. The first cover layer 141 substantially covers the entire exposed portion of the color filter layer 120 between the pixel electrodes PE1 and PE2. For example, the first cover layer 141 may have a thickness of about 0.4 μm to about 0.6 μm, and a width of about 5 μm to about 8 μm.

The column spacer 142 protrudes from the display substrate 100 in a region in which the gate line 220 crosses the data line 240, and has a greater height than the first cover layer 141. The column spacer 142 may be formed on the TFT 250. For example, the column spacer 142 may have a height of about 1.0 μm to about 1.5 μm, and a maximum width of about 10 μm to about 15 μm.

A photo-curable resin layer having a negative photoresist or a positive photoresist characteristic is coated on the color filter layer 120 having the pixel electrodes PE1 and PE2 formed thereon, and the photo-curable resin layer is partially removed through a photo process to form the first cover layer 141 and the column spacer 142. Alternatively, the first cover layer 141 comprising a thermosetting resin may be formed through an ink jet deposition process or a flat printing process. The first cover layer comprising various materials may be formed through various methods to prevent impurities of the color filter layer 120 from migrating through the alignment layer 150.

Referring again to FIGS. 1 and 2, the alignment layer 150 is formed on the pixel electrode layer 130 having the first cover layer 141 and a column spacer 142 formed thereon. The pixel electrode layer 130 and the first cover layer 141 are interposed between the alignment layer 150 and the color filter layer 120 to prevent direct contact between the alignment layer 150 and the color filter layer 120.

Referring again to FIG. 3, an opening 132 is formed in the pixel electrode layer 130 which divides each of the pixel regions into a plurality of domains, thereby increasing a viewing angle. Alternatively, a plurality of openings 132 may be formed in each of the pixel electrodes PE1 and PE2.

When the opening 132 is formed in the first pixel electrode PE1, a second cover layer 144 is formed on the opening 132 to cover a portion of the color filter layer 120 that is exposed through the opening 132. The second cover layer 144 prevents direct contact between the color filter layer 120 and the alignment layer 150 through the opening 132 of the first pixel electrode PE1. The second cover layer 144 may be formed from substantially the same layer as the first cover layer 141 and the column spacer 142, and may comprise substantially the same material as the first cover layer 141 and the column spacer 142. The second cover layer 144 may be simultaneously formed with the first cover layer 141 and the column spacer 142.

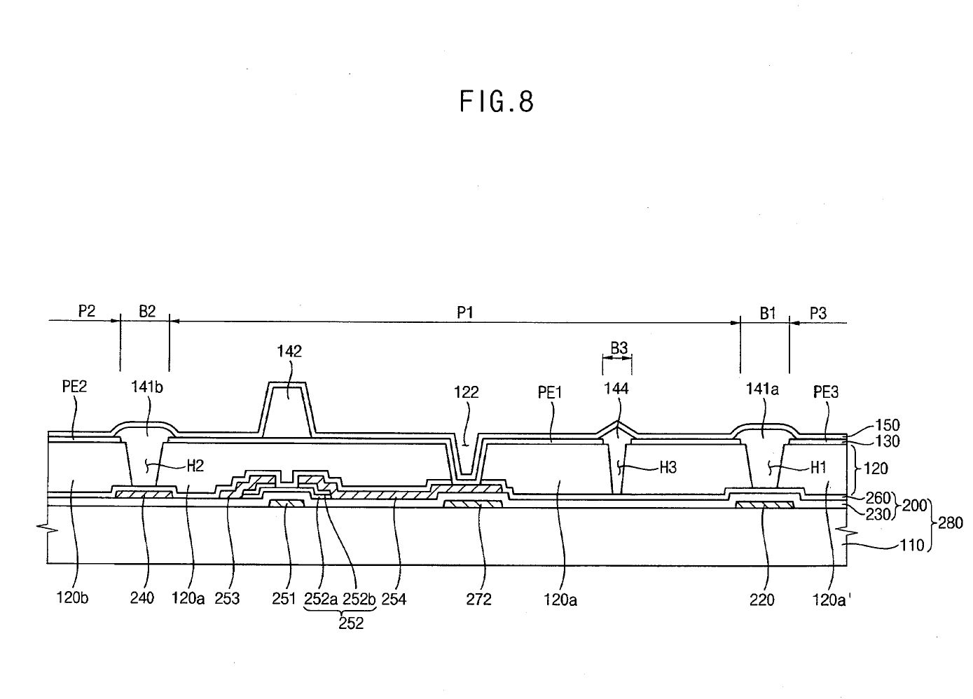

FIG. 8 is a cross-sectional view illustrating a display substrate in accordance with another embodiment of the present invention. In particular, FIG. 8 is a cross-sectional view illustrating line II-II′ shown in FIG. 3. Thus, the same reference numerals will be used to refer to the same or like parts as those described in FIG. 3 and any further description concerning the above elements will be omitted.

Referring to FIGS. 3 and 8, the display substrate comprises a thin film transistor layer 280, a color filter layer 120, a pixel electrode layer 130, a first and second cover patterns 141a and 141b, a second cover layer 144 and an alignment layer 150.

The thin film transistor layer 280 comprises an insulating substrate 110 and a pixel layer 200 that is formed on the insulating substrate 110. The pixel layer 200 comprises a plurality of gate lines 220, a gate insulating layer 230, a plurality of data lines 240, a thin film transistor 250 and a passivation layer 260. The thin film transistor layer 280 of FIG. 8 is substantially the same as in FIG. 2. Thus, any further description concerning the above elements will be omitted.

The color filter layer 120 is formed on the pixel layer 200. The color filter layer 120 comprises a plurality of color filters 120a and 120b. In FIGS. 3 and 8, a first color filter 120a formed in a first pixel region P1 has a different color from a second color filter 120b formed in a second pixel region P2 that is adjacent to the first pixel region P1 on the opposite side of the data line 240.

The first color filter 120a formed in the first pixel region P1 is substantially the same color as a third color filter 120a′ formed in the third pixel region P3 that is adjacent to the first pixel region P1 on the opposite side of the gate line 220. That is, the first and third color filters 120a and 120a′ are formed in the first and third pixel regions P1 and P3, respectively, and the second color filter 120b is formed in the second pixel region P2.

A portion of the color filter layer 120 corresponding to a boundary between the pixel regions P1, P2 and P3 is removed to form a groove. In particular, a portion of the first color filter 120a corresponding to a first boundary region B1 between the first and third pixel regions P1 and P3 is removed to form a first groove H1, and an overlapped portion of the color filter layer 120 between the first and second color filters 120a and 120b in a second boundary region B2 between the first and second pixel regions P1 and P2 is removed to form a second groove H2. In addition, a portion of the first color filter 120a corresponding to the opening 132 that divides each of the pixel regions P1, P2 and P3 into a plurality of domains is removed to form a third groove H3 on a third boundary region B3.

When the first and second cover patterns 141a and 141b and second cover layer 144 are not formed on the color filter layer 120, impurities may exit the color filter layer 120 through the first, second and third boundary regions B1, B2 and B3. However, in FIG. 8, portions of the color filter layer 120 corresponding to the first, second and third boundary regions B1, B2 and B3 are removed, and the first and second cover patterns 141a and 141b and second cover layer 144 cover the regions so that an afterimage phenomenon caused by the impurities can be decreased.

Alternatively, only first and second grooves H1 and H2 may be formed in the first and second boundary regions B1 and B2. Only second groove H2 may also be formed in the second boundary region B2. Alternatively, a depth of each of the grooves H1, H2 and H3 may be substantially the same as of the color filter layer 120. The depth of each of the grooves H1, H2 and H3 may also be less than the thickness of the color filter layer 120.

The pixel electrode layer 130 is patterned to form the pixel electrodes PE1, PE2 and PE3 corresponding to the pixel regions P1, P2 and P3. In particular, the first pixel electrode PE1 is in the first pixel region P1, and the second pixel electrode PE2 is in the second pixel region P2. The third pixel electrode PE3 is in the third pixel region P3. The opening 132 is formed in each of the pixel electrodes PE1, PE2 and PE3 to form the domains in each of the pixel regions P1, P2 and P3. The drain electrode 254 of the thin film transistor 250 is electrically connected to each of the pixel electrodes PE1, PE2 and PE3 through the contact hole 122.

The first cover layer comprises a first cover pattern 141a and a second cover pattern 141b. The first cover pattern 141a is formed in the first boundary region B1 to fill the first groove H1, and covers end portions of the first and third pixel electrodes PE1 and PE3 that are adjacent to each other. The second cover pattern 141b is formed in the second boundary region B2 to fill the second groove H2, and covers end portions of the first and second pixel electrodes PE1 and PE2 that are adjacent to each other. The first and second cover patterns 141a and 141b prevent the color filter layer 120 from being exposed.

The height of each of the first and second cover patterns 141a and 141b above the pixel electrode layer 130 may be about 0.4 μm to about 0.6 μm, and a width of each of the first and second cover patterns 141a and 141b may be about 5 μm to about 8 μm. Each of the first and second cover patterns 141a and 141b may have a substantially flat upper surface. In FIG. 8, the first and second cover patterns 141a and 141b do not affect the operation of the liquid crystals. That is, the first and second cover patterns 141a and 141b are in a region in which the liquid crystals are uncontrollable. Each of the first and second cover patterns 141a and 141b may have a substantially flat surface. Alternatively, each of the first and second cover patterns may have various shapes.

The column spacer 142 may be formed substantially from the same layer as and may comprise substantially the same material as the first and second cover patterns 141a and 141b. The height of the column spacer 142 may be about 1.0 μm to about 1.5 μm, and the maximum width of the column spacer 142 may be about 10 μm to about 15 μm.

The second cover layer 144 is formed in the third boundary region B3 to fill the third groove H3, and covers a portion of the first pixel electrode PE1 adjacent to the opening 132. The second cover layer 144 prevents the color filter layer 120 from being exposed.

In FIG. 8, the second cover layer 144 is formed in each of the pixel regions P1, P2 and P3 in which operation of the liquid crystals is controlled. The second cover layer 144 may have a substantially peaked shape having a side surfaces that form an angle of about 12 degrees to 15 degrees with respect to an upper surface of the color filter layer 120 (as shown from the perspective illustrated in FIG. 8). The two side surfaces meet at a peak in the middle of the second cover layer 144. The height and width of the second cover layer 144 are determined by a depth, width and angle of inclination of the opening 132. For example, the height of the second cover layer 144 above the pixel electrode layer 130 may be about 0.4 μm to about 0.6 μm, and the width of the second cover layer 144 may be about 5 μm to about 10 μm.

The alignment layer 150 is formed on the pixel electrode layer 130, the column spacer 142, the first and second cover patterns 141a and 141b and the second cover layer 144. The alignment layer 150 aligns the liquid crystals to form a predetermined direction. The first and second cover patterns 141a and 141b and the second cover layer 144 prevent impurities from the color filter layer 120 from reaching the alignment layer 150.

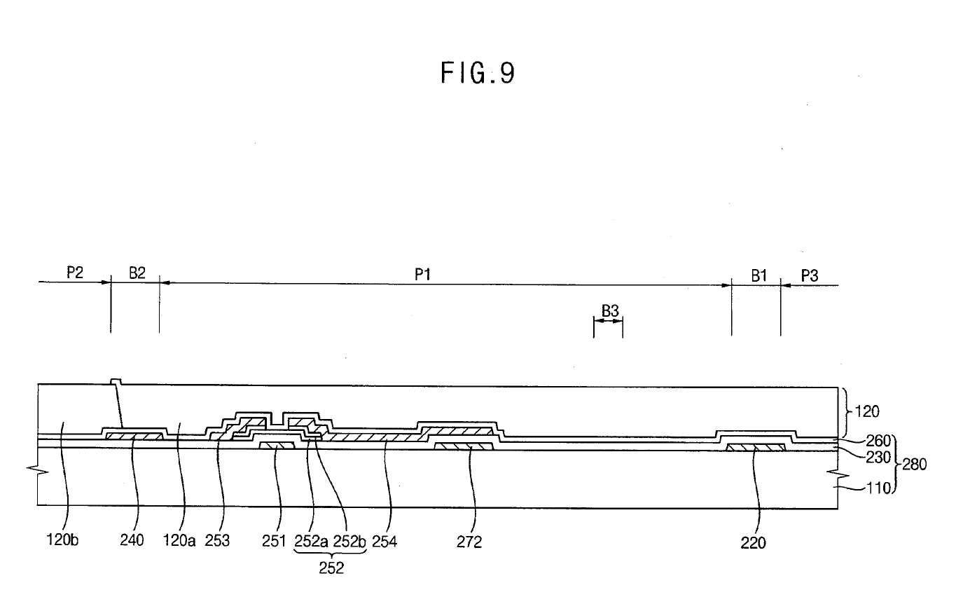

FIGS. 9 to 13 are cross-sectional views illustrating a method of manufacturing a display substrate shown in FIG. 8.

Referring to FIGS. 3 and 9, a pixel layer 200 comprising a plurality of pixel regions arranged in a matrix shape is formed on an insulating substrate 110. The process for forming the pixel layer 200 of FIG. 9 is substantially the same as in FIG. 7. Thus, the same reference numerals will be used to refer to the same or like portions as those described in FIG. 7 and any further description concerning the above elements will be omitted.

A color filter layer 120 is formed on the insulating substrate 110 having the passivation layer 260. In particular, a plurality of color filters are formed on the insulating substrate 110 to form the color filter layer 120.

In particular, a red color filter layer is formed on the insulating substrate 110, and is patterned to form a red color filter in one of the pixel regions. A green color filter layer is formed on the insulating substrate 110, and is patterned to form a green color filter in another of the pixel regions. A blue color filter layer is formed on the insulating substrate 110, and is patterned to form a blue color filter in another of the pixel regions.

In FIG. 9, a color filter 120a having a single color is formed in a first boundary region B1 on the gate line 220, and color filters 120a and 120b having different colors from each other are formed in a second boundary region B2 on the data line 240.

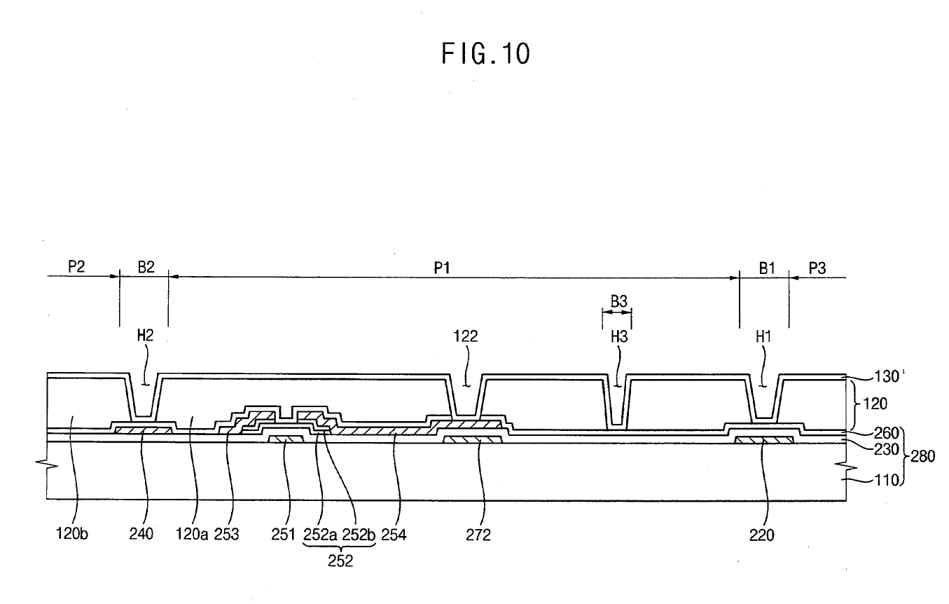

Referring to FIGS. 3 and 10, a contact hole 122 is formed to expose the electrode 254 of a thin film transistor. In addition, the color filters 120a and 120b on the first, second and third boundary regions B1, B2 and B3 are partially removed to form the first, second and third grooves H1, H2 and H3. The first, second and third grooves H1, H2 and H3 may be formed with the contact hole 122.

For example, the color filters 120a and 120b are partially removed so that the passivation layer 260 is exposed through the first, second and third grooves H1, H2 and H3. A pixel electrode layer 130 is deposited on the insulating substrate 110 on which the contact hole 122, and the first, second and third grooves H1, H2 and H3 are formed. The pixel electrode layer 130 is electrically connected to the drain electrode 254 through the contact hole 122.

In FIG. 10, the first, second and third grooves H1, H2 and H3 are formed during the same process step as the formation of the contact hole. Alternatively, the first and second grooves H1 and H3 may be formed during the same process step as the formation of the color filters 120a and 120b, and only the second groove H2 is formed in the same process step as the contact hole.

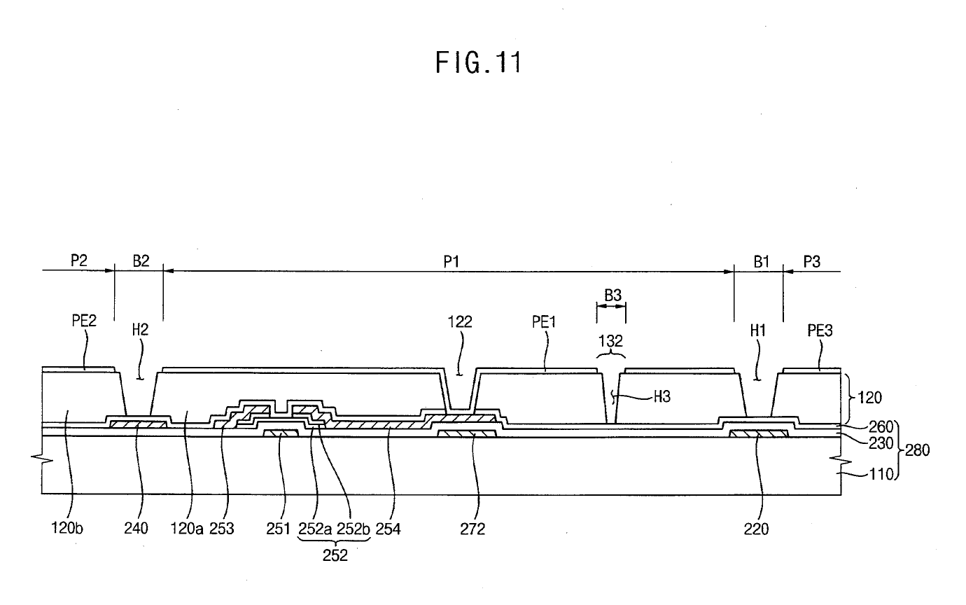

Referring to FIGS. 3 and 11, the pixel electrode layer 130 is patterned to form a first pixel electrode PE1, a second pixel electrode PE2 and a third pixel electrode PE3. The first, second and third pixel electrodes PE1, PE2 and PE3 are formed in a first pixel region P1, a second pixel region P2 and a third pixel region P3, respectively. That is, the pixel electrode layer 130 corresponding to the first, second and third boundary regions B1, B2 and B3 are partially removed to form the first, second and third pixel electrodes PE1, PE2 and PE3. For example, a protrusion having a substantially peaked shape is formed in the opening 132 of the pixel electrode layer 130, and a width of the opening 132 may be about 1 μm to about 5 μm, thereby increasing an aperture ratio of the pixel regions P1, P2 and P3.

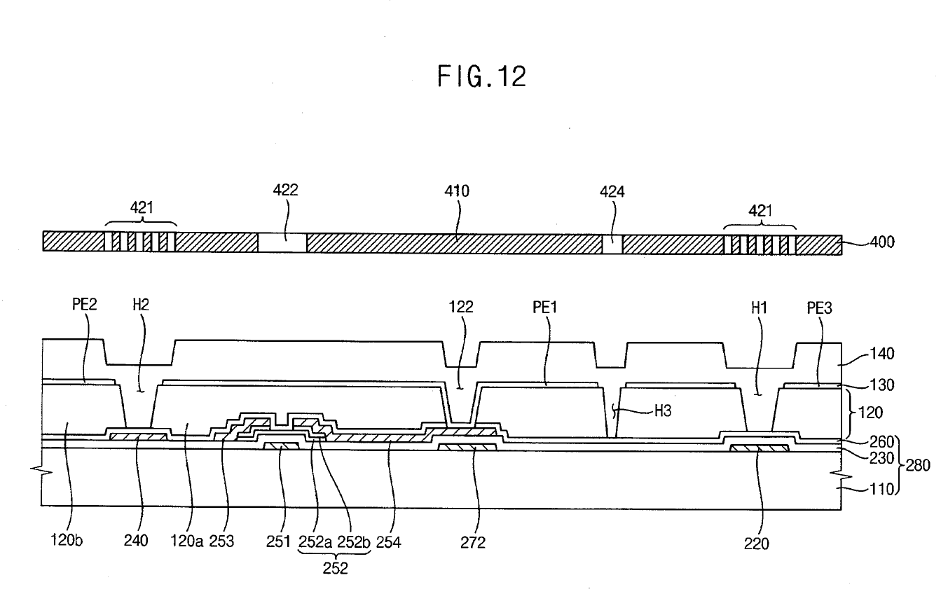

Referring to FIGS. 3 and 12, a light curable resin layer 140 is formed on the insulating substrate 110 having the patterned pixel electrode layer 130. The light curable resin formed on the insulating substrate 110 may comprise a negative photoresist or a positive photoresist. The light curable resin layer 140 fills the first, second and third grooves H1, H2 and H3, and covers the color filter layer 120.

The photo-curable resin layer 140 is patterned using a mask 400 to form the first and second cover patterns 141a and 141b, a column spacer 142 and a second cover layer 144. The first and second cover patterns 141a and 141b are formed in the first and second boundary regions B1 and B2 between the pixel electrodes PE1, PE2 and PE3. The column spacer 142 is formed on the thin film transistor 250. The second cover layer 144 is formed in the third boundary region B3 corresponding to the opening 132.

In particular, the mask 400 comprises a slit portion 421, a first transmitting portion 422 and a second transmitting portion 424. The slit portion 421 corresponds to the first and second boundary regions B1 and B2. The first transmitting portion 422 corresponds to the column spacer 142. The second transmitting portion 424 corresponds to the second cover layer 144, and is smaller than the first transmitting portion 422.

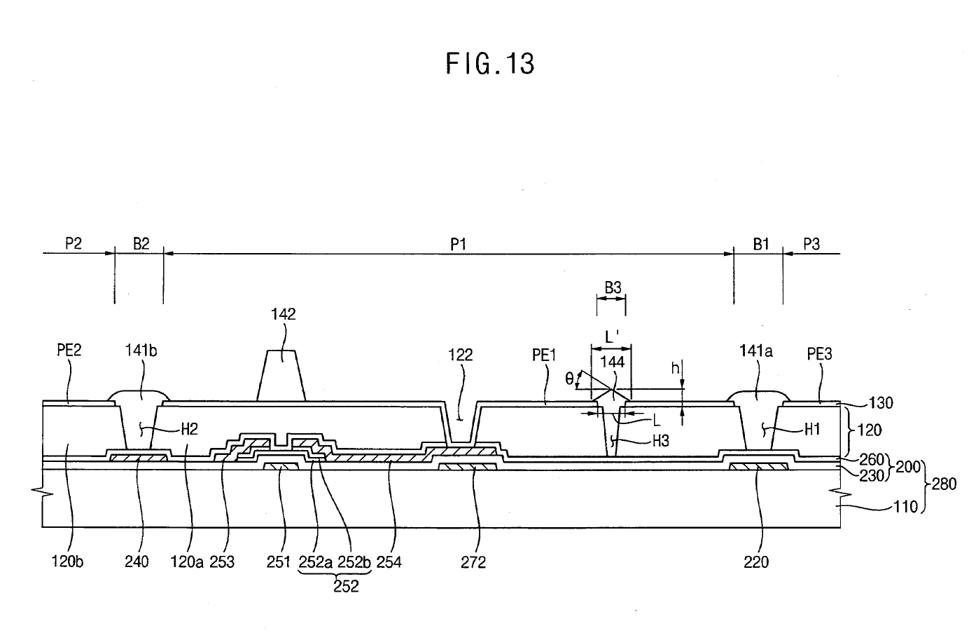

Referring to FIGS. 3, 12 and 13, a first cover pattern 141a and a second cover pattern 141b are formed in the first and second boundary regions B1 and B2 by the slit portions 421. The first and second cover patterns 141a and 141b cover the first and second grooves H1 and H2. Each of the first and second cover patterns 141a and 141b protrudes from an upper surface of the color filter layer 120, and has a substantially flat upper surface. In FIG. 13, the first and second cover patterns 141a and 141b do not affect the operation of liquid crystals. That is, the first and second cover patterns 141a and 141b are in a region in which the liquid crystals are not controllable. Each of the first and second cover patterns 141a and 141b may have a substantially the flat surface between the first and third pixel electrodes PE1 and PE3 and between the first and second pixel electrodes PE1 and PE2. For example, a height of each of the first and second cover patterns 141a and 141b above the pixel electrode layer 130 may be about 0.4 μm to about 0.6 μm, and the maximum width of each of the first and second cover patterns 141a and 141b may be about 5 μm to about 10 μm.

The column spacer 142 is formed by the first transmitting portion 442, and the second cover layer 144 is formed in the third boundary region B3 by the second transmitting portion 444. For example, the column spacer 142 may have a height of about 1.0 μm to about 1.5 μm, and a maximum width of about 10 μm to about 15 μm.

The second cover layer 144 fills the third groove H3, and protrudes from the color filter layer 120. The second cover layer 144 may have a substantially peaked shape. The second cover layer 144 is formed in the first pixel region P1 to control an operation of the liquid crystals. For example, the second cover layer 144 has a substantially peaked shape including an inclined surface forming an angle θ of about 12 degrees to about 15 degrees.

The second cover layer 144 covers the opening 132 having a predetermined width L to increase a response speed of the liquid crystals and to increase an aperture ratio of the pixel regions P1, P2 and P3. A height h and a width L′ of the second cover layer 144 are determined by the width L of the opening 132 and the angle θ of the peaked shape. For example, the height h of the second cover layer 144 above the pixel electrode layer 130 may be about 0.4 μm to about 0.6 μm, and the maximum width L′ of the second cover layer 144 may be about 5 μm to about 10 μm.

In FIG. 13, the first and second cover patterns 141a, 141b, the second cover layer 144, and the column spacer 142 may comprise substantially the same material, may be formed on substantially the same layer, and may be formed using substantially the same photo process. Alternatively, the first and second cover patterns 141a and 141b may be formed through an ink jet process using a thermosetting resin or a flat printing process.

An alignment layer 150 (shown in FIG. 8) is formed on substantially the entire surface of the insulating substrate 110.

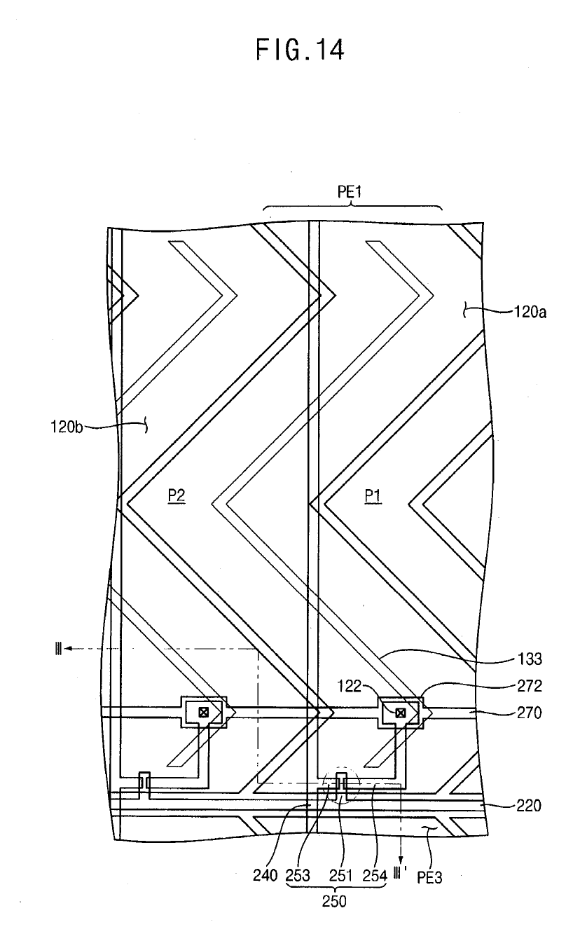

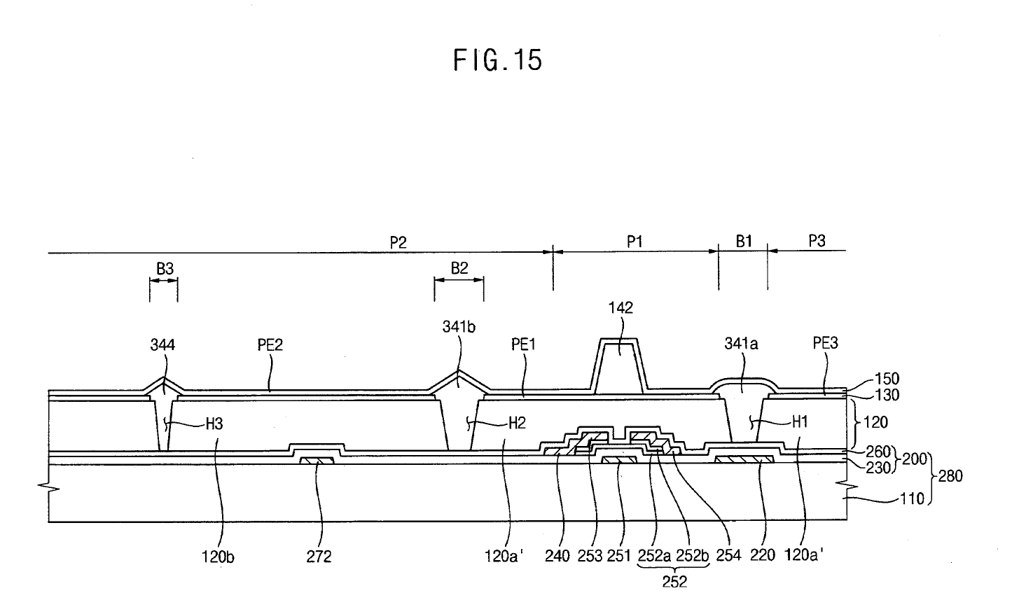

FIG. 14 is a plan view illustrating a display substrate in accordance with another embodiment of the present invention. FIG. 15 is a cross-sectional view taken along line III-III′ of FIG. 14.

Referring to FIGS. 14 and 15, the display substrate comprises a thin film transistor layer 280, a color filter layer 120, a pixel electrode 130, a first cover pattern 341a and 341b, a second cover layer 344 and an alignment layer 150.

The thin film transistor layer of FIGS. 14 and 15 is substantially the same as in FIGS. 1 and 2. Thus, the same reference numerals will be used to refer to the same or like parts as those described in FIGS. 1 and 2 and any further description concerning the above elements will be omitted. The thin film transistor layer 280 comprises an insulating substrate 110 and a pixel layer 200 on the insulating substrate 110. The pixel layer 200 comprises a gate line 220, a gate insulating layer 230, a data line 240, a thin film transistor 250 and a passivation layer 260. Alternatively, the pixel layer 200 may further include a plurality of gate lines 220, a plurality of data lines 240 and a plurality of thin film transistors 250. A plurality of pixel regions P1, P2 and P3 are defined by the gate and data lines 220 and 240.

In particular, the data line 240 defines a boundary between the first pixel region P1 from an adjacent second pixel region P2, and the gate line 220 defines a boundary between the first pixel region P1 from an adjacent third pixel region P3. The thin film transistor 250 and a storage capacitor electrode 272 electrically connected to a storage line 270 are formed in the first pixel region P1. The thin film transistor 250 comprises a gate electrode 251, an active layer 252, a source electrode 253 and a drain electrode 254.

The color filter layer 120 comprises a plurality of color filters 120a and 120b formed in a plurality of pixel regions, respectively. A first color filter 120a of the color filter layer 120 is bent to have a zigzag shape when viewed from the perspective illustrated in FIG. 14, and is on a portion of the first pixel region P1 and a portion of the second pixel region P2. A second color filter 120b of the color filter layer 120 is bent to form a zigzag shape when viewed from the perspective illustrated in FIG. 14, and is on a portion of the second pixel region P2. That is, the first and second color filters 120a and 120b are both formed at least in part in the second pixel region P2. In other words, it is possible to have several color filters in a pixel region.

A third color filter 120a′ having a zigzag shape when viewed from the perspective illustrated in FIG. 14 is formed in the third pixel region P3 that is adjacent to the first pixel region P1 on the opposite side of the gate line 220. The third color filter 120′ has a substantially same shape as the first color filter 120a.

The color filter layer 120 has a first groove H1 and a second groove H2. A portion of the first color filter layer 120a in the first boundary region B1 corresponding to the gate line 220 is removed to form the first groove H1. A portion of the first and second color filters 120a and 120b in the second boundary region B2 in which the first and second color filters 120a and 120b are partially overlapped are removed to form the second groove H2. In addition, a portion of the second color filter 120b in the third boundary region B3 corresponding to the opening 133 of the second pixel electrode P2 is removed to form a third groove H3. The second pixel electrode PE2 is formed on the second color filter 120b. In other embodiments, fewer grooves may be formed. For example, only the first and second grooves H1 and H2 may be formed. In FIG. 15, the portions of the color filter layer 120 corresponding to the first, second and third grooves H1, H2 and H3 are completely removed so that each of the first, second and third grooves H1, H2 and H3 extends through the color filter layer 120 sufficiently far so as to contact the structure underneath the color filter layer 120. Alternatively, the portions of the color filter layer 120 corresponding to the first, second and third grooves H1, H2 and H3 may be partially removed so that the depth of each of the first, second and third grooves H1, H2 and H3 is less than the thickness of the color filter layer 120.

The pixel electrode layer 130 comprises a plurality of pixel electrodes PE1 and PE2 corresponding to the color filters 120a and 120b, respectively. The first pixel electrode PE1 includes the opening 133 which divides the first pixel region P1 into a plurality of domains.

In particular, the first pixel electrode PE1 is formed to have a zigzag shape to correspond to the zigzag shape of the first color filter 120a. The first pixel electrode PE1 may have substantially the same shape as the first color filter 102a (as viewed from the perspective shown in FIG. 14). That is, the first pixel electrode PE1 is formed in both the first and second pixel regions P1 and P2. The second pixel electrode PE2 is formed in the second pixel region P2. The third pixel electrode PE3 is adjacent to the first pixel electrode PE1 on the opposite side of the gate line 220.

Each of the pixel electrodes PE1 and PE2 is electrically connected to the drain electrode 254 of the thin film transistor 250 through a contact hole 122.

The first cover layer comprises a first cover pattern 341a and a second cover pattern 341b. The first cover pattern 341 a is formed in the first boundary region B1 to fill the first groove H1 which is in between the end portions of the adjacent first and third pixel electrodes PE1 and PE3. For example, a height of the first cover pattern 341a above the pixel electrode layer 130 may be about 0.4 μm to about 0.6 μm, and a maximum width of the first cover pattern 341a may be about 5 μm to about 8 μm. An upper surface of the first cover pattern 341a is substantially flat. The first cover pattern 341a is formed in a region that does not affect the driving of the liquid crystals, and thus the first cover pattern 341a may have a substantially flat upper surface.

The second cover pattern 341b is formed in the second boundary region B2 to fill the second groove H2 which is in between the end portions of the adjacent first and second pixel electrodes PE1 and PE2. The second cover pattern 341b is formed in the second pixel region P2 in which the liquid crystals are controlled, and has a substantially peaked shape including an inclined surface forming an angle of about 12 degrees to about 15 degrees. For example, a height of the second cover pattern 341b above the pixel electrode layer 130 may be about 0.4 μm to about 0.6 μm and a maximum width of the second cover pattern 341b may be about 5 μm to about 10 μm.

The column spacer 342 may be formed from substantially the same layer as the first cover layer 341a and 341b, and may comprise substantially the same material. For example, a height of the column spacer 342 may be about 1.0 μm to about 1.5 μm, and a maximum width of the column spacer 342 may be about 10 μm to about 15 μm.

The second cover layer 344 is formed in the third boundary region B3 to fill the third groove H3, and covers a portion of the first pixel electrode PE1, which is adjacent to the opening 133.

The second cover layer 344 is formed in the second pixel region P2 in which the liquid crystals are controlled, and has a substantially peaked shape. For example, the second cover layer 344 has an inclined surface forming an angle of about 12 degrees to about 15 degrees with respect to an upper surface of the color filter layer 120. The height and width of the second cover layer 344 are determined by the width of the opening 133 and the angle of the inclined surface of the opening 133. For example, the height of the second cover layer 344 above the pixel electrode layer 130 may be about 0.4 μm to about 0.6 μm, and the maximum width of the second cover layer 344 may be about 5 μm to about 10 μm.

The alignment layer 150 is formed on the pixel electrode layer 130, the column spacer 342, the first cover layer 341a and 341b and the second cover layer 344. The alignment layer 150 aligns the liquid crystals that are on the alignment layer 150 in a predetermined direction. The alignment layer 150 is separated from the color filter layer 120 by the first and second cover layers 341a, 341b and 344 and the pixel electrode layer 130. Thus, because the cover layers 341a, 341b and 344 are interposed between the color filter layer 120 and the alignment layer 150, these impurities do not migrate into the liquid crystal layer through the alignment layer 150.

A method of manufacturing the display substrate of FIGS. 14 and 15 is substantially the same as in FIGS. 9 to 13 except with respect to the second cover pattern 341b. Thus, the same reference numerals will be used to refer to the same or like parts as those described in FIGS. 9 to 13 and any further description concerning the above elements will be omitted.

The second cover pattern 141b of FIG. 13 has a substantially flat surface. However, the second cover pattern 341b of FIG. 15 has the substantially peaked shape. In FIGS. 14 and 15, the second cover pattern 341b is formed between the pixel electrodes PE1 and PE2 having the zigzag shape so that the second cover pattern 341b is formed in the second pixel region P2. That is, the second cover pattern 341b is formed in the second pixel region P2 in which the liquid crystals are controlled to have the substantially peaked shape including the inclined surface forming the angle of about 12 degrees to about 15 degrees with respect to the upper surface of the color filter layer 120.

The second cover pattern 341b of FIGS. 14 and 15 is patterned through the substantially same process for patterning the second cover layer 144 in FIG. 13. Thus, any further description concerning the above elements will be omitted.

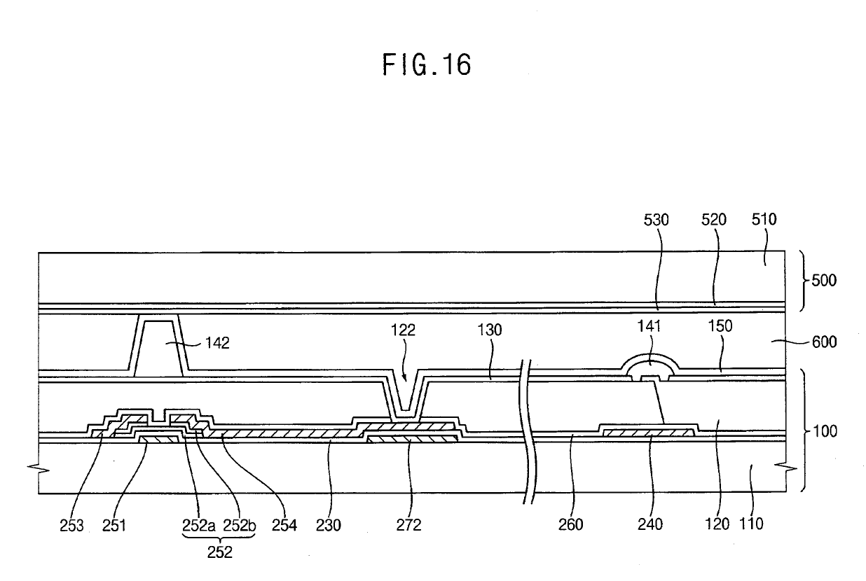

FIG. 16 is a cross-sectional view illustrating a display device in accordance with another embodiment of the present invention.

Referring to FIG. 16, the display device 300 comprises a display substrate 100, an opposite substrate 500 and a liquid crystal layer 600. The opposite substrate 500 faces the display substrate 100, and is coupled to the display substrate 100. The liquid crystal layer 600 is interposed between the display substrate 100 and the opposite substrate 500.

The display substrate 100 of FIG. 16 may be the same as the display substrate 100 described above with respect to FIGS. 1 and 2. Thus, the same reference numerals will be used to refer to the same or like parts as those described in FIGS. 1 and 2 and any further description concerning the above elements will be omitted.

The opposite substrate 500 comprises an insulating substrate 510, a common electrode 520 and an alignment layer 530. The common electrode 520 is formed on the insulating substrate 510. The alignment layer 530 is formed on the common electrode 520.

The common electrode 520 is formed on a surface of the insulating substrate 510 corresponding to the display substrate 100. The common electrode 520 comprises a transparent conductive material to enable light to be transmitted through the opposite substrate 500. The transparent electrode 520 may comprise substantially the same material as a pixel electrode layer 130. Examples of the transparent conductive material that can be used for the common electrode 520 include indium zinc oxide (IZO), indium tin oxide (ITO), etc.

The liquid crystal layer 600 comprises a plurality of liquid crystals, which can be arranged in predetermined directions. The liquid crystals of the liquid crystal layer 600 have optical characteristics such as anisotropy of refractivity, and electrical characteristics such as anisotropy of dielectric constant. The arrangement of the liquid crystals vary in response to an electric field applied between the pixel electrode 130 and the common electrode 520. As a result, light transmittance of the liquid crystal layer 600 can be controlled.

According to the display substrate, the method of manufacturing the display substrate and the display device having the display substrate, the color filter layer formed on the display substrate does not make direct contact with the alignment layer through the gap between the adjacent pixel electrodes, thereby preventing deterioration of the liquid crystals due to contaminants from the color filter layer. Therefore, an afterimage caused by the deterioration of the liquid crystals is decreased, thereby improving the image display quality.

In addition, the cover layer formed in the region in which the liquid crystals are not controllable has a substantially flat shape, and the cover layer formed in the region in which the liquid crystals are controllable has a substantially peaked shape. In addition, the cover layer may also control an arrangement of the liquid crystals to improve the response speed of the liquid crystals. This invention has been described with reference to the example embodiments. It is evident, however, that many alternative modifications and variations will be apparent to those having skill in the art in light of the foregoing description. Accordingly, the present invention embraces all such alternative modifications and variations as falling within the spirit and scope of the appended claims.

What is claimed is:

1. A display substrate comprising:
a thin film transistor layer comprising a plurality of pixel regions;
a color filter layer formed on the thin film transistor layer;
a plurality of pixel electrodes formed on the color filter layer, the pixel electrodes defining at least one gap between adjacent pixel electrodes;
a first cover layer provided in the gap between adjacent pixel electrodes, said first cover layer covering a portion of the color filter layer exposed by the gap between the adjacent pixel electrodes; and
an alignment layer formed on the pixel electrodes and the first cover layer.

2. The display substrate of claim 1, further comprising a first groove in the color filter layer corresponding to the gap between the adjacent pixel electrodes.

3. The display substrate of claim 2, wherein the first cover layer is formed in the first groove.

4. The display substrate of claim 1, wherein each pixel region in the thin film transistor layer comprises:
a gate line on an insulating substrate;
a data line crossing the gate line; and
a thin film transistor electrically connected to the gate and data lines.

5. The display substrate of claim 4, wherein the first cover layer comprises:
a first cover pattern formed in uncontrollable regions corresponding to the gate lines and the data lines; and
a second cover pattern formed in pixel regions between the gate lines and the data lines.

6. The display substrate of claim 5, wherein the first cover pattern has a substantially flat surface.

7. The display substrate of claim 5, wherein the second cover pattern has a substantially peaked shape.

8. The display substrate of claim 1, wherein a height of the first cover layer above the pixel electrodes is about 0.4 μm to about 0.6 μm.

9. The display substrate of claim 1, wherein a width of the first cover layer is about 5 μm to about 8 μm.

10. The display substrate of claim 9, wherein the color filter layer has a zigzag shape.

11. The display substrate of claim 10, wherein the pixel electrodes has the same shape of the color filter layer.

12. The display substrate of claim 1, wherein each of the pixel electrodes comprises a plurality of domains separated by at least one opening.

13. The display substrate of claim 12, further comprising a second cover layer that covers an exposed portion of the color filter layer that is exposed through the opening.

14. The display substrate of claim 13, wherein the second cover layer and the first cover layer comprise substantially the same material.

15. The display substrate of claim 13, wherein the second cover layer has a substantially peaked shape.

16. The display substrate of claim 13, wherein the color filter layer has a second groove corresponding to the opening.

17. The display substrate of claim 16, wherein the second cover layer is formed on the second groove to cover an exposed portion of the color filter layer that is exposed through the opening.

18. The display substrate of claim 1, further comprising a column spacer having a height greater than the first cover layer.

19. The display substrate of claim 18, wherein the first cover layer comprises substantially the same material as the column spacer.

20. The display substrate of claim 1, wherein each pixel electrode comprises at least one opening dividing the pixel electrode into a plurality of domains, and the display substrate further has a second groove in the color filter layer corresponding to the opening.

21. The display substrate of claim 1, wherein each pixel electrode comprises at least one opening dividing the pixel electrode into a plurality of domains, and at least one domain extends across a plurality of pixel regions.

22. The display substrate of claim 1, wherein each pixel electrode comprises at least one opening dividing the pixel electrode into a plurality of domains, and each domain has a zigzag shape.

23. The display substrate of claim 1, wherein each pixel electrode comprises at least one opening dividing the pixel electrode into a plurality of domains, and the display substrate further comprises a second cover layer that covers an exposed portion of the color filter layer exposed through the at least one opening.

24. A method of manufacturing a display substrate comprising:
forming a thin film transistor layer comprising a plurality of pixel regions on an insulating substrate;
forming a color filter layer on the thin film transistor layer;
forming a plurality of pixel electrodes on the color filter layer;
forming a first cover layer that covers a portion of the color filter layer between pixel electrodes; and
forming an alignment layer on the pixel electrodes and the first cover layer.

25. A display device comprising:
a display substrate, comprising:
a thin film transistor layer comprising a plurality of pixel regions;
a color filter layer formed on the thin film transistor layer;
a plurality of pixel electrodes formed on the color filter layer, the pixel electrodes defining at least one gap between adjacent pixel electrodes;
a cover layer provided in the gap between adjacent pixel electrodes, said cover layer covering a portion of the color filter layer exposed by the gap between the adjacent pixel electrodes; and
a first alignment layer formed on the pixel electrodes and the cover layer;
an opposite substrate combined with the display substrate, the opposite substrate facing the display substrate; and
a liquid crystal layer interposed between the display substrate and the opposite substrate.

26. The display device of claim 25, wherein the opposite substrate comprises:
a common electrode formed on an insulating substrate facing the display substrate; and
a second alignment layer formed on the common electrode.
